(19) United States
(12) Patent Application Publication
(10) Pub. No.: US 2007/0170162 A1
(43) Pub. Date: Jul. 26, 2007

(54) Method and device for cutting through semiconductor materials

(76) Inventors: Oliver Haupt, Hannover (DE); Bernd Lange, Neustadt a.Rbge (DE)

Correspondence Address: SHLESINGER, ARKWRIGHT & GARVEY LLP, 1420 KING STREET, SUITE 600, ALEXANDRIA, VA, 22314, US

(21) Appl. No.: 11/598,821

(22) Filed: Nov. 14, 2006

Related U.S. Application Data
(63) Continuation of application No. PCT/EP05/03422, filed on Apr. 1, 2005.

(30) Foreign Application Priority Data
May 14, 2004 (DE) 10 2004 024 475.8

(51) Int. Cl. B23K 26/38

(52) U.S. Cl. 219/121.72; 219/121.67; 438/463

(57) ABSTRACT

Method for cutting through a semiconductor material, includes providing a semiconductor material, and directing a laser beam toward a cutting zone of the semiconductor material. Method further includes selecting a wavelength of the laser beam such that the laser beam is partially transmitted by the semiconductor material under partial absorption, in use, the wavelength of the laser radiation ranging from approximately 1100 to approximately 1150 nm. The wavelength of the laser radiation is selected such that the transmittance of the semiconductor material is approximately 30 to approximately 60%. The method makes possible a rapid and precise cutting through of semiconductor materials, such as wafers. A device for cutting through semiconductor material likewise is provided for cutting through semiconductor materials, such as a wafer.

### FIELD OF THE INVENTION

The invention relates to a method and a device for cutting through semiconductor materials, especially silicon.

### BACKGROUND OF THE INVETION

From WO 02/48059 a method for cutting through components made of glass, ceramic, glass ceramic or similar materials by generating a thermally induced stress crack along a cutting zone is known. In this method, a laser beam generated using a Nd:YAG laser is directed multiple times through the component that is to be cut, in order to increase the amount of laser radiation that is absorbed. To expand the stress crack, the component and the laser beam are moved relative to each other. With the method known from WO 02/48059, however, only materials such as glass, glass ceramic or similar materials that have an amorphous structure, and in which no relevant change in optical properties occurs in a temperature range of 0 to 350° Celsius, can be processed.

Methods for cutting through components made of material that is prone to cleavage fracture are further known from EP 0 448 168 B1 and JP 10-244386.

From the publication “Thermal Stress Cleaving of Brittle Materials by Laser Beam” by Ueda, T.; et al. from the Faculty of Engineering, Kanazawa University, Japan; CIRP Vol. 51/1/2002, a method for cutting through silicon using thermally induced stresses is known. In this method, pulsed and continuously emitting Nd:YAG lasers are used.

Furthermore, in the publication “Wafer Dicing by Laser Induced Thermal Shock Process” by KaiDong Ye et al.; National University of Singapore; SPIE Proceedings Vol. 4557 (2001), a method of the relevant type for cutting through silicon wafers using thermally induced stresses is described, in which a pulsed Nd:YAG laser is also used. In this manner, the laser radiation causes a heating of the component surface, whereby a stress profile is created by a downstream cooling process, which results in a selective crack formation.

The Nd:YAG lasers used in these known processes generate a laser beam having a wavelength that is very highly absorbed by semiconductor materials and thus penetrates only in the surface area of the component that is to be cut through. Therefore a stress crack forms only in the area of the heated surface, which then further propagates uncontrolled inside the material.

A similar process is also known from U.S. 2002/0115235 A1.

### OBJECTS AND SUMMARY OF THE INVENTION

It is thus the object of the invention to disclose a method and a device that will enable semiconductor materials to be cut through with great precision.

This object is attained with the method according to claim 1, or the device according to claim 12.

According to the invention, the wavelength of the laser radiation ranges from approximately 1,100 to approximately 1,150 nm, especially from 1,115 to 1,125 nm, wherein the wavelength of the laser radiation is chosen such that the transmittance of the semiconductor material amounts to approximately 30 to approximately 60%, especially approximately 45 to 55%.

The invention is based upon the fact that the optical properties of semiconductor materials are temperature-dependent. In particular, within a large wavelength range absorption increases with increasing temperature. With the selection of the wavelength for the laser beam according to the invention it is ensured that, even as the temperature of the semiconductor material increases, the optical properties, and thereby the absorption of the laser radiation by the semiconductor material, is changed only slightly, i.e. increases. Thus it is ensured that the laser beam in part penetrates completely through the semiconductor material under partial absorption, and is not essentially absorbed only on the surface, where it would result in a localized heating. Rather, the semiconductor material to be cut through undergoes a homogeneous volume heating. In this manner a stress crack is prevented from forming only in the area of the surface of the semiconductor material and then propagating uncontrolled through the material. It is instead achieved with the invention that the crack formation takes place both on the surface and in the volume of the semiconductor material. In this manner, the cutting can be performed under controlled conditions.

A particular advantage of the method of the invention consists in the fact that an unintended formation of fissures and micro-cracks is prevented, and during the cutting process no waste products are formed that could accrete onto the semiconductor material.

The semiconductor material can be germanium, gallium arsenide or other semiconductor materials. However it is preferably provided that the semiconductor material is silicon, as silicon has attained the widest use in the semiconductor industry. In this manner especially integrated circuits, solar cells or microstructures produced on silicon wafers can be separated. In addition, as compared with the known methods for separating the integrated circuits, solar cells or microstructures that involve sawing the silicon wafer, the yield per surface area can be increased, as dicing lines of narrower width than are required for sawing are sufficient for this.

It is preferably provided that the wavelength of the laser beam lies within the near infrared range, in which the absorption behavior of semiconductor materials is not or is only very slightly dependent upon temperature.

In one preferred embodiment it is provided that the laser beam is generated using an ytterbium fiber laser, wherein the ytterbium fiber laser preferably has a wavelength of 1120 nm. In this manner, the laser source used to generate the laser beam is preferably operated in CW mode.

The method can be implemented by transmitting the laser beam through the semiconductor material a single time. However it is preferably provided that the laser beam is directed multiple times through the cutting zone of the semiconductor material. In this manner, after the transmitted portion of the laser beam exits the semiconductor material it is redirected back to the cutting zone of the semiconductor material by a reflecting means.

To increase the effectiveness and cost-effectiveness of the cutting process, it is possible to arrange multiple layers of semiconductor material, for example wafers made of silicon, stacked one on top of another and to guide the laser beam through these multiple wafers. In this manner, both the uppermost wafer and the wafers arranged beneath the wafer are penetrated by the laser beam under partial absorption.

The semiconductor material is preferably heated in the area of the cutting zone to 150 to 500° Celsius, especially up to 350° Celsius, as tests have shown that at these temperatures the formation of a crack in the semiconductor material can be caused.

In one preferred embodiment it is provided that multiple laser beams are directed toward multiple cutting zones. In this manner, a semiconductor material that is to be cut can be cut through multiple times at the same time, so that the method enables a particularly rapid separation of the integrated circuits, solar cells, microstructures, etc. To accomplish this a corresponding multiple of laser sources can be provided, or alternatively a laser beam can be divided.

In a further embodiment it is provided that the laser beam is reflected by a metal coating of the semiconductor material. In this manner a reflector can be eliminated, and instead the metal coating, which customarily is applied to the back side of wafers, can be used as the reflector. Thus the transmitted portion of the laser radiation can be reflected by the metal coating and directed back through the interior of the wafer to the cutting zone.

The device disclosed in claim 12 for cutting through semiconductor material includes a laser source, which emits a laser beam at a wavelength that is partially transmitted by the semiconductor material with simultaneous partial absorption, and a means for directing the laser beam onto a cutting zone for the semiconductor material. According to the invention, the laser source emits a laser beam having a wavelength of approximately 1,100 to approximately 1,150 nm, especially 1,115 to 1,125 nm, wherein according to the invention the wavelength of the laser radiation is chosen such that the transmittance of the semiconductor material amounts to approximately 30 to approximately 60%, especially 45 to 55%.

Preferably, the device is structured for processing the semiconductor materials silicon, germanium or gallium arsenide.

In one preferred embodiment it is provided that the semiconductor material has a thickness of 30 to 1,000 μm, especially 350 to 600 μm. Thus the device of the invention is especially well suited for separating integrated circuits or microstructures on wafers made of silicon, germanium or gallium arsenide, the thickness of which measures, for example, between 350 and 600 μm.

In one preferred embodiment, the laser source emits laser radiation at a near-infrared wavelength.

It is preferably provided that the laser source includes an ytterbium fiber laser, which is tuned to a wavelength of 1120 nm.

In one preferred embodiment, the laser source used to generate the laser beam is structured for operation in CW mode.

In a further embodiment, the device includes a reflective means for guiding the laser beam multiple times through the semiconductor material, so that the transmitted portion of the laser radiation is reversed and passes through the semiconductor material in the area of the cutting zone, thus intensifying the heating. Alternatively, the device can include a means for dividing the laser beam and for directing a first partial beam from the upper side onto the semiconductor material, and for directing the second from the underside of the semiconductor material onto the semiconductor material. Rather than the means for dividing the laser beam, two laser sources may also be used.

The device is preferably structured for cutting through multiple semiconductor materials, for example silicon wafers, arranged in layers. In this manner at least two wafers can be cut through at the same time using the transmitted portion of the laser radiation, which has penetrated through the uppermost wafer.

In one preferred embodiment, the laser source is structured for heating the semiconductor material in the cutting zone to a temperature of 150 to 500° Celsius, especially to 350° Celsius.

The device preferably includes a bearing surface for the semiconductor material. The support of the semiconductor material on the bearing surface ensures that the cutting process is not impaired by externally induced mechanical stresses. Externally induced mechanical stresses are understood according to the invention as those mechanical stresses that are not thermally induced by the laser radiation. By preventing or reducing externally induced mechanical stresses it is ensured that only those mechanical stresses that are thermally induced via the laser will form in the semiconductor material and will lead in a controlled manner to a thermally induced stress crack. In this manner, an overlapping of the mechanical stresses that are thermally induced via the laser with unintended, externally induced mechanical stresses, which could impair the cutting process, especially in terms of its precision, is prevented.

In one preferred embodiment it is provided that the bearing surface is structured as a reflector. In this manner, the bearing surface can be a part of an electrostatic mount that is made of metal. In this embodiment, the need to synchronously guide the reflector and the laser beam in a movement along a cutting line on both sides of the semiconductor material to be processed is omitted. Thus this construction of the device is particularly simple and inexpensive.

In a further preferred embodiment, the bearing surface is made of a material that is highly transmissive for the laser beam, so that the transmitted portion of the laser beam, once it has been reflected by a reflector back in the direction of the semiconductor material, crosses through the bearing surface and again passes through the cutting zone of the semiconductor material. In this manner, the bearing surface can be formed by a plastic film that includes an adhesive coating. This selection of material for the bearing surface prevents the bearing surface from being heated by the transmitted portion of the laser radiation, and thereby causing an undesired heating of the semiconductor material.

The laser source preferably has an initial output of 2 to 200 watts. Thus temperatures of 150-500° Celsius, preferably 350° Celsius, can be generated. At these temperatures, a stress crack can be generated in semiconductor materials without any further measures, resulting in a cutting through, so that the device of the invention is preferably suited for separating integrated circuits, solar cells or microstructures that have been produced on a wafer.

In one preferred embodiment, the device is equipped with a means for directing multiple laser beams onto multiple cutting zones in the semiconductor material. For this purpose, the device can include multiple laser sources, or a means for dividing a laser beam from a laser source. With the device, multiple cutting processes can then be implemented simultaneously along desired cutting lines, so that the separation of integrated circuits, solar cells or microstructures with this device can be implemented particularly rapidly and thereby economically.

In another embodiment, it is provided that a means for at least partially removing a metal coating from the semiconductor material is provided. This means for the at least partial removal can, for example, comprise an additional laser source, with which the metal coating can be removed at least in the area of the cutting zone, so that in this area can exit from the wafer. The transmitted portion of the laser beam can then be directed via a reflective means the transmitted portion of the laser radiation back onto the cutting zone of the semiconductor material.

In a further preferred embodiment it is provided that the device is structured for cutting semiconductor material having metal coatings. Thus with this device, for example, a wafer that includes metallization on its back side can be processed. The back metallization serves as a reflective means for the transmitted portion of the laser radiation, which is reflected on the metal coating and is guided back through the cutting zone of the wafer. This device includes no further reflective devices and therefore has a particularly simple construction.

Below, the invention will be described in greater detail with reference to the attached set of drawings, in which an exemplary embodiment of a device according to the invention is represented in a highly schematic fashion. In this manner, all characterizing features that are described or are represented in the drawings, alone or in any combination, form the object of the invention, regardless of their combination in the patent claims or their reference, and regardless of their formulation or representation in the description or in the drawings.

The drawings show:

### BRIEF DESCRIPTION OF THE DRAWINGS

FIG. 1: a highly schematic representation of a structure of a device according to the invention for cutting through semiconductor material; and

FIG. 2: a cross section of a semiconductor material.

### DETAILED DESCRIPTION OF THE INVENTION

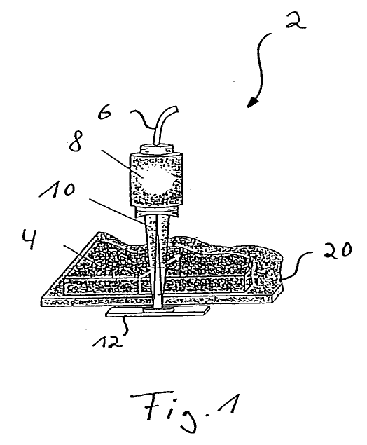

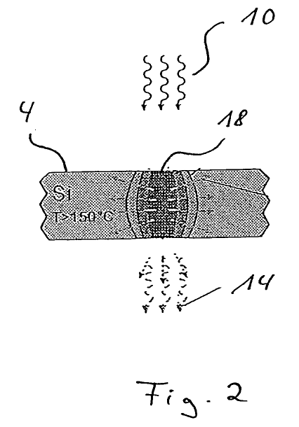

The following refers to FIGS. 1 and 2.

A device 2 according to the invention for cutting through semiconductor material includes a processing head 8, to which a laser beam is directed via an optical fiber 6, and that is generated by a laser source having an ytterbium fiber laser. The ytterbium fiber laser is tuned to a wavelength of 1120 nm.

The processing head 8 directs the laser beam 10 emerging from the optical fiber 6 with an essentially punctiform beam spot onto a cutting zone 18 of the semiconductor material that is to be cut, for example a section of a silicon wafer 4 having a thickness of 350 to 600 μm.

In this manner, the wavelength of the laser beam 10 is selected to be 1120 nm, such that the laser beam 10 is not absorbed exclusively on the surface of the wafer 4, and instead passes through the entire thickness of the wafer 4, and a transmitted portion of the laser radiation 14 exits from the underside of the wafer 4. In this manner, the increasing heating of the wafer 4 in the wavelength range of the laser radiation that is used does not alter the optical properties of the silicon, or does so to only a slight degree, so that even with increasing heating to a temperature above 150° Celsius, the optical absorption properties of the silicon with respect to the laser radiation that is used do not change significantly. Accordingly, even with a corresponding temperature change, the laser radiation continues to be partially transmitted under partial absorption.

During the cutting process, the wafer is supported on a bearing surface 20, which in this exemplary embodiment is structured to be essentially flat and is made of a material that is highly transmissive for the laser radiation at the wavelength that is used. In this manner it is ensured that the bearing surface does not become heated to any notable degree, so that an unintended heating of the wafer 4 is prevented.

Beneath the bearing surface 20 a reflector 12 is arranged, with which the transmitted portion of the laser radiation 14 can be directed back to the cutting zone 18 of the wafer 4. In this manner, the transmitted portion of the laser radiation 14 passes through the bearing surface 20 a second time, before the reflected laser beam again penetrates the wafer 4.

In order to heat and cut the wafer 4 along a desired cutting line, a means, not illustrated in the drawings, is provided, which moves the processing head 8 relative to the component during the processing, according to the course of the cutting line. In this manner, the reflector 12 can be moved together with the processing head 8. If the reflector 12 includes a sufficiently large reflective surface to reflect the laser radiation along the cutting line during the entire movement of the processing head 8 relative to the wafer 4, however, the reflector 12 can also be arranged fixed in place. Alternatively, the laser beam can also be guided using a scanner, especially a galvo scanner.

Alternatively, it can also be provided that the bearing surface 20 is configured as a reflective means, so that it is then necessary only to move the processing head 8 along the desired cutting line, while the bearing surface 20 that is configured as a reflector is arranged fixed in place.

If the wafer 4 includes a back metallization, this should be removed prior to the cutting process, in order to allow the transmitted portion of the laser radiation 14 to exit from the wafer 4. The device can include another laser for this purpose, which removes the back metallization from the wafer 4 at least in the regions of the cutting zone or cutting line 18, in order to allow the transmitted portion of the laser radiation 14 to exit from the wafer 4.

As an alternative to this, however, the back metallization of the wafer 4 can also be used as a reflective surface, so that the transmitted portion of the laser radiation 14 does not exit from the wafer 4, and instead is reflected on the metallization applied to the underside of the wafer 4, and again passes through the interior of the wafer in the area of the cutting zone 18. As a result of the formation of a thermally induced stress crack in the wafer 4, a cutting through of the back metallization on the underside of the wafer 4 occurs at the same time, so that the cutting through of the back metallization in a further processing step can be omitted.

In order, for example, to cut through a wafer 4 that includes multiple integrated circuits or microstructures, to allow the further processing of these components, the wafer 4 is placed on the bearing surface 20. The processing head 8 is then oriented so that the laser beam 10 impacts on the cutting zone 18 of the wafer 4. When the laser is activated, the laser beam 10 is transmitted to the wafer 4 under partial absorption, wherein the transmitted portion of the laser radiation 14 impacts upon the reflector 12 and penetrates back through the bearing surface 20 into the semiconductor material of the wafer 4.

These multiple passes of the laser radiation through the wafer 4 with simultaneous partial absorption cause a homogeneous heating of the wafer over its entire thickness, wherein the mechanical stresses generated by this heating, once a certain temperature has been reached, and after a subsequent cooling, result in the formation of a crack.

With the synchronous traversing of the processing head 8 and the reflector 12, a desired cutting line is traced on the surface of the wafer 4, and the wafer 4 is cut through in the desired manner. This process is repeated until all integrated circuits or microstructures on the wafer have been separated. The separated integrated circuits or microstructures can then be further processed, for example they can be glued into housings and wired.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Method for cutting through a semiconductor material, comprising:
a) providing a semiconductor material;
b) directing a laser beam toward a cutting zone of the semiconductor material;
c) selecting a wavelength of the laser beam such that the laser beam is partially transmitted by the semiconductor material under partial absorption, in use;
d) the wavelength of the laser radiation ranging from approximately 1100 to approximately 1150 nm;
e), the wavelength of the laser radiation being selected such that the transmittance of the semiconductor material is approximately 30 to approximately 60%.

2. Method according to claim 1, wherein:
a) the semiconductor material is silicon.

3. Method according to claim 1, wherein:
a) the wavelength of the laser beam lies within the near infrared region.

4. Method according to claim 1, wherein:
a) the laser beam is generated using an ytterbium fiber laser.

5. Method according to claim 4, wherein:
a) the ytterbium fiber laser has a wavelength of 1120 nm.

6. Method according to claim 1, wherein:
a) the laser beam is operated in the CW mode.

7. Method according to claim 1, wherein:
a) the laser beam is guided multiple times through the cutting zone of the semiconductor material.

8. Method according to claim 1, wherein:
a) the semiconductor material includes multiple layers; and
b) the laser beam is guided through multiple layers of the semiconductor material.

9. Method according to claim 1, wherein:
a) the semiconductor material is heated in the area of the cutting zone to 150 to 500° Celsius.

10. Method according to claim 1, wherein:
a) the cutting zone includes multiple cutting zones;
b) the laser beam includes multiple laser beams; and
c) the multiple laser beams are directed toward the multiple cutting zones.

11. Method according to claim 1, wherein:
a) the semiconductor material includes a metal coating; and
b) the laser beam is reflected on the metal coating of the semiconductor material.

12. Device for cutting through semiconductor material, comprising:
a) a laser source for emitting a laser beam at a wavelength that is partially transmitted by the semiconductor material under partial absorption, in use;
b) a device configured for directing the laser beam toward a cutting zone of the semiconductor material, in use; and
c) the laser source configured for emitting a laser beam having a wavelength ranging from approximately 1100 to approximately 1150 nm, the wavelength of the laser radiation being selected such that the transmittance of the semiconductor material is approximately 30 to approximately 60%, in use.

13. Device according to claim 12, wherein:
a) the semiconductor material is silicon, germanium or gallium arsenide, in use.

14. Device according to claim 12, wherein:
a) the semiconductor material has a thickness of 30 to 1000 μm, in use.

15. Device according to claim 12, wherein:
a) the laser source emits laser radiation at a near infrared wavelength.

16. Device according to claim 12, wherein:
a) the laser source has an ytterbium fiber laser.

17. Device according to claim 12, wherein:
a) a reflective device is provided, the reflective device being configured for guiding the laser beam multiple times through the semiconductor material.

18. Device according to claim 12, wherein:
a) the device is configured for cutting a plurality of layered semiconductor materials.

19. Device according to claim 12, wherein:
a) the device includes a bearing surface for the semiconductor material.

20. Device according to claim 19, wherein:
a) the bearing surface includes a reflector.

21. Device according to claim 20, wherein:
a) the bearing surface includes a material that is transmissive for the laser radiation, in use.

22. Device according to claim 12, wherein:
a) the laser source has an initial output of 2 to 200 watts.

23. Device according to claim 12, wherein:
a) the laser source is configured for heating the semiconductor material at the cutting zone to a temperature of 150 to 500° Celsius.

24. Device according to claim 12, wherein:
a) a device is provided for directing multiple laser beams toward multiple cutting zones in the semiconductor material, in use.

25. Device according to claim 12, wherein:
a) a device is provided for at least partially removing a metal coating of the semiconductor material, in use.

26. Device according to claim 23, wherein:
a) the laser source is configured for heating the semiconductor material at the cutting zone to a temperature of 350° Celsius.

27. Device according to claim 12, wherein:
a) the semiconductor material has a thickness of 350 to 600 μm.

28. Device according to claim 12, wherein:
a) the wavelength of the laser radiation ranges from approximately 1115 to 1125 nm.

29. Device according to claim 12, wherein:
a) the wavelength of the laser radiation is selected such that the transmittance of the semiconductor material is approximately 45 to 55%.

30. Method according to claim 9, wherein:
a) the semiconductor material is heated in the area of the cutting zone to 350° Celsius.

31. Method according to claim 1, wherein:
a) the wavelength of the laser radiation ranges from approximately 1115 to 1125 nm.

32. Method according to claim 1, wherein:
a) the wavelength of the laser radiation is selected such that the transmittance of the semiconductor material is approximately 45 to 55%.
